(19) United States
(12) Patent Application Publication
(10) Pub. No.: US 2008/0233922 A1
(43) Pub. Date: Sep. 25, 2008

(54) System and Method for Remotely Monitoring Equipment with the Aid of at Control, Device, Radiocommunications Module and Corresponding Program

(75) Inventor: Sebastien Lesrel, Paris (FR)

Correspondence Address: WESTMAN CHAMPLIN & KELLY, P.A., SUITE 1400, 900 SECOND AVENUE SOUTH, MINNEAPOLIS, MN, 55402-3244, US

(73) Assignee: Wavecom, Issy-Les-Moulineaux Cedex (FR)

(21) Appl. No.: 10/592,740

(22) PCT Filed: Feb. 25, 2005
(86) PCT No.: PCT/FR05/00463

§ 371 Date: Sep. 14, 2006

(30) Foreign Application Priority Data
Mar. 15, 2004 (FR) 0402670

(51) Int. Cl. H04L 12/58; H04Q 7/32

(52) U.S. Cl. 455/412.1; 455/425

(57) ABSTRACT

The invention relates to a system for remotely monitoring equipment which makes it possible to interconnect at least one server and at least one remote equipment according to a predetermined protocol. The inventive system is associated with at least one remote equipment of radiocommunications means emitting and receiving AT instructions emitted by and/or destined for an external application carried out by said remote equipment. Said means is provided with a set of specific instructions making it possible to manage the data exchange between said remote equipment and at least one server performing said protocol, wherein at least one of said instructions enables said radiocommunications means to produce, modify and/or to send format XML pages.

### CROSS-REFERENCE TO RELATED APPLICATION

This Application is a Section 371 National Stage Application of International Application No. PCT/FR2005/000463, filed Feb. 25, 2005 and published as WO 2005/101739 on Oct. 27, 2005, not in English.

### FIELD OF THE DISCLOSURE

The field of the disclosure is that of the remote monitoring of equipment and particularly equipment limited in data processing resources. The disclosure thus applies to remote data logging systems, for example on water, gas or electricity meters, and more generally to telemetry, command tracking, and more generally machine to machine control systems.

### BACKGROUND

There are already miscellaneous solutions for implementing such operations. They have generally been developed specifically for a given application. In other words, they are “proprietary” solutions, which are difficult to adapt to other applications.

Furthermore a protocol is known, developed by the IBM and ARCOM Control Systems companies (trademarks), known under the technological name “MQIsdp Messaging”. This technique proposes a communication protocol between one or more equipment of limited resource, and one or more servers or “brokers”, using a TCP/IP link.

However, even with this specific protocol, it is necessary to add specific processing means (microprocessors, memories, etc.) to the equipment, which allows a dialogue to be established with these remote servers, using the requisite MQIsdp format. The connection between the equipment and the server may use a telephone-type connection, via a modem.

In many applications, it would however be desirable to be able to do without a wire telephone connection. It may then be conceivable to employ radio-communication means in accordance with the GSM or GPRS standard for example.

The Orange Company (trademark) has thus offered a service, known as <<M2M Connect >> (trademark), defined particularly in the specification documents “Orange M2M Protocol Definition”. This service is offered in the form of a ready-to-use solution, offering communication, monitoring and service level functions.

In this case, a wireless telephony equipment will be used to provide the modem function. However, it remains necessary, in accordance with the prior art, to associate with the equipment specific and proprietary data-processing means to establish and implement the data exchange with the server.

Thus, in the case of the “M2M Connect” service, the remote terminals must have significant means at their disposal to manage a communication (for example in GPRS), so as to construct messages in a format that can be accepted by the remote servers, and where appropriate to manage the compression of these messages. A specific application must therefore be developed and associated with each terminal, which is generally incompatible with any requirement to reduce the cost of the latter or to simplify them (for example when electric meters, distributed in very great quantities, are involved).

This aspect constitutes a very significant limitation on the development of the aforementioned applications, and many other applications that are conceivable under this technique.

### SUMMARY

An embodiment of the present disclosures is directed to a system for the remote monitoring of equipment, allowing interconnection between at least one server and at least one remote equipment according to a given protocol.

According to an embodiment of the invention, this system associates with at least one of said remote equipment radiocommunication means able to send and receive AT type commands sent by and/or intended an external application implemented by said remote equipment, and said radiocommunication means are endowed with a set of specific AT commands allowing data exchanges to be managed between said remote equipment and at least one server implementing said given protocol, at least one of said AT commands allowing said radio-communication means to create, modify and/or send pages in the XML format, so as to allow interconnection between said server(s) and the remote equipment(s) via said radio-communication means by transmitting pages in the XML format, without requiring any knowledge of said given protocol nor the XML format in said remote equipment(s).

Thus, it is possible to manage data exchanges easily and straightforwardly, without it being necessary to develop specific applications or associate significant means (microprocessor and memory particularly) with a terminal.

Neither the latter, nor the associated application, needs to know the protocol used by the server, or the XML format. It is the radio-communication means which manage these aspects. The only knowledge required, from the point of view of the application and therefore of the terminal, is the new AT commands of an embodiment of the invention (which can, as will be seen subsequently, be relatively small in number).

According to one advantageous characteristic of an embodiment of the invention, at least one of said AT commands allows transmission data to be compressed. Said compression may in particular implement the WBXML compression format.

To advantage, at least in a first transmission mode, said data is transmitted on a channel dedicated to short messages (SMS). Preferentially, at least in a second transmission mode, said data is transmitted on a GPRS channel.

In said second operating mode, the system of an embodiment of the invention employs to advantage a “peer-to-peer” protocol, using the TCP protocol, and for example the BEEP protocol.

To advantage, the system of an embodiment of the invention includes means for the implementation, in a first operating mode, of a service for the automatic sending and/or receipt of at least one XML message stored in said radiocommunication means, on receipt of a wake-up message.

This allows the processing to be effectively simplified.

In this way, the system is able to provide four operating modes:
automatic mode, in which it manages a transaction autonomously;
manual mode, in which a transaction must be initiated by a remote application;
automatic input/manual output mode in which only incoming messages are processed automatically;
manual input/automatic output mode, in which a message is sent automatically.

Preferentially, an embodiment of the invention uses simplified XML pages XML, comprising only:
tag names;
attribute names;
attribute values; and/or
data.

According to one preferential aspect of an embodiment of the invention, said given protocol is a protocol implemented in the frame of a service that implements an XML data description language, an algorithm for the compression of said WBXML data, a first method of access to at least one server via GPRS and a second method of access to a second server via SMS. This may in particular be the “M2M Connect” service developed by the Orange Company (trademark).

To advantage, said radiocommunication means integrate said protocol in the form of an “Open-AT” application, specifying said set of specific AT commands.

Said set of specific AT commands preferentially includes commands allowing:
connection to one of said servers;
the sending of messages;
the receipt of messages.

Preferentially, at least some of said specific AT commands are organised so as to be able to provide at least two functions and/or to act on at least two different aspects, as a function of a pre-set parameterisation.

This makes it possible to significantly reduce the number of necessary commands, while providing all the necessary operations and allowing any future developments to be taken into account.

Thus, in a preferential embodiment, said set of commands comprises only 8 commands.

To advantage, said set of specific AT commands includes at least one configuration command allowing the parameters of the communication to be defined with one of said servers.

Preferentially, it implements a single configuration command (+M2MGSET) for the general configuration of aspects related to said protocol and/or said service.

Said consideration command is able particularly to allow a transmission mode to be selected from at least two (SMS and GPRS).

To advantage, said configuration command also allows an operating mode to be selected from at least two, an automatic operating mode and a manual operating mode.

In this case, said configuration command may further be used to set a deadline for the handling of a message, in said automatic operating mode.

According to another aspect of an embodiment of the invention, at least three configurations commands are employed:
a command for the general configuration of aspects related to said protocol and/or said service (+M2MGSET);
a connection configuration command (+M2MCSET), allowing the coordinates of a server to be specified;
a command for the configuration of the configuration message of a table for implementing a syntactic analyser for compression (+M2MWBXML).

According to one advantageous characteristic of an embodiment of the invention, provision is made for:
at least in a first mode, said radiocommunication means to manage only the signalling of a data exchange, said data being transferred directly from a piece of remote equipment to a server, or vice versa; and/or
at least in a second mode, said radiocommunication means to manage the signalling of a data exchange and the transfer of said data, the latter being stored temporarily in at least one buffer memory.

To advantage, in this case, characterised in that the size of said buffer memory or memories can be parameterised. Provision is made to advantage for the system to operate in said first mode when the size of said buffer memory or memories has the value 0, and in said second mode otherwise.

A straightforward and effective means is thus obtained to fulfill two functions (choice of mode and queue dimensioning for example) with a single command.

Preferentially, at least one general communication command is used, allowing messages to be sent and/or received according to said given protocol.

In particular, at least five general communication commands may be provided:
a command for managing a connection with a server (+M2MCONM);
a sending message send command (+M2MSMSG);
an XML message creation and/or modification command (+M2MCMSG);
a receipt message receive command (+M2MRMSG);
an administration command, allowing a set of parameters (+M2MPA)to be reseted and/or returned to the default values.

An embodiment of the invention includes, to advantage, an XML message creation and/or modification command (+M2MCMSG) allowing at least some of the following operations to be performed:
starting the creation of an XML message in an output buffer;
writing a start indicator;
writing an attribute;
writing data;
writing an end indicator;
end of page creation;
modifying an attribute value;
modifying a data value,
   a parameter making it possible to determine the type of operation to which said creation and/or modification command is assigned.

According to another advantageous aspect, at least one interrogation command is implemented by an external application, and preferentially four interrogation commands by an external application in one of said remote equipment, in relation respectively to:
the current status of the connection (+M2MCONI);
the sending of a message (+M2MSMSGI);
the receipt of a message (+M2MRMSGI);
the syntactic analysis “parsing” of a message (+M2MPMSGI).

An embodiment of the invention also relates to a process for the remote monitoring of equipment, allowing interconnection between at least one server and at least one remote equipment according to a given protocol, in a system as described above.

An embodiment of the invention further relates to radiocommunication devices and radiocommunication modules that include radiocommunication means employed in such a system for the remote monitoring of equipment.

An embodiment of the invention also relates to computer programs that include programming instructions allowing AT type commands to be employed in a remote equipment and/or in radiocommunication means in a system for the remote monitoring of equipment as described above.

Other characteristics and advantages will emerge more clearly from reading the following description of one embodiment of the invention, given as a straightforward illustrative and non-restrictive example.

### BRIEF DESCRIPTION OF THE DRAWINGS

FIG. 1 shows an example of a system in which an embodiment of the invention is able to be implemented;

FIG. 2 is an example of the integration of an embodiment of the invention into an Open-AT application;

FIG. 3 shows an example of the use of a connection according to an embodiment of the invention.

### DETAILED DESCRIPTION OF THE ILLUSTRATIVE EMBODIMENTS

### 1. General Points

The disclosure therefore relates to an new approach to the remote monitoring of equipment, based particularly on implementing a set of specific AT commands that allow an external application to manage data exchanges between a remote terminal and a server, via radiocommunication means (for example a Wismo (trademark) module distributed by the applicant of the present patent application), without the application knowing the protocol used by the server or the XML format. It is the radiocommunication means which manage this aspect, and for example the verification operations, the formatting of the messages and any compression thereof.

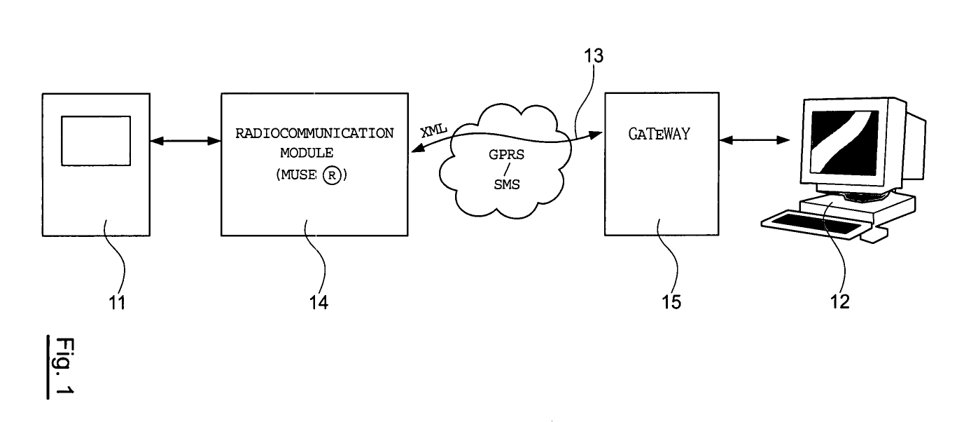

FIG. 1 shows, in a simplified way, the principle of an embodiment of the invention. The objective is to bring any kind of remote machines into communication with each other, for example measuring instruments (meters) 11, with one or more applications hosted by servers 12, via a gateway 15 managed by the telephone operator, able to receive XML data 13 according to at least one given protocol, and to convert, process or transmit it.

According to an embodiment of the invention, radiocommunication means 14 are associated with the remote terminals (or machines) 11, for example in the form of a Wismo (trademark) module, having on board in particular development tools distributed by the applicant under the “Muse platform” mark.

### 2. General Presentation of the Protocol

In the embodiment described hereinafter, the system of the embodiment is provided for the “Orange M2M Connect” (trademark) service.

The “Orange M2M Connect” product is a ready-to-use solution offering communication, monitoring and service level functions. This product is supplied in the form of a telemetry cabinet.

According to an embodiment of the invention, Wavecom (trademark) products (modules in particular) offer options that can be used with the “Orange M2M Connect” protocol:
Handling XML messages: the module is able to create and analyse light XML messages;
Handling WBXML: this option allows data to be compressed before it is transmitted, thus improving the use of the SMS channel;
BEEP protocol: this is a balanced protocol initially designed for the computer (PC) world. “M2M Connect” requires only the use of a straightforward part in its system run on the TCP protocol.

This protocol defines the communication between remote terminals (“terminals”) and the “M2M Telemetry” system (“the system”). The messages may then be reassembled by the host systems (or “servers”) using an HTTP protocol via an M2M gateway.

Schematically, the remote terminals communicate with the host system, through the GPRS network, and the system, which acts as a storage and routing system. The system also provides the protocol monitoring aspect.

The SmartBeep protocol is an application protocol, which defines a communication between an application run on a remote terminal and the system application. SmartBeep is based on Beep integrated software. The SmartBeep protocol uses “API BeepCore” which supports the TCP protocol at a lower level, but most of these operations are hidden for the applications developer.

The general communication process takes the form of an exchange transaction, the different stages of which are defined as follows:
The terminal starts by originating a call to the GPRS base station. This means negotiating with the GPRS network which is responsible for the authentication and which also specifies the system IP/port for the terminal and the system IP/port the terminal needs in order to communicate with the next one. This will be the address of the server hosting the M2M system.
The terminal opens the specified IP/port and sets up a TCP session with the M2M system.
The terminal may ask to start downloading any incoming message waiting for collection at gateway level. The gateway opens a new data channel and sends each message in the form of an individual SmartBeep message. The terminal must acknowledge receipt of each message by sending a response message to the system. When the system has finished sending all the messages, a “No More Messages” message is sent to the terminal. The terminal acknowledges receipt of the “No More Messages” message and the system closes the downlink channel.
The terminal transfers all the system's outgoing messages, sends them in the form of individual SmartBeep messages. The system acknowledges receipt of each message by sending a response message to the terminal. When the terminal has finished sending all the messages, a “No More Messages” message is sent to the system.
The system acknowledges receipt of the “No More Messages” message and considers that the communication is over.
The terminal ends its connection to the GPRS network.

Under an embodiment of the invention, these operations are performed by the radiocommunication means (module) and not directly by the remote terminal.

### 3. Observations about XML Messages

The “Orange M2M Connect” solution uses properly adapted XML documents to send, receive and manage data.

To handle these XML documents easily, the AT command interface according to an embodiment of the invention proposes a number of commands for analyzing the documents received and facilitating the creation and modification of XML documents to be sent.

An XML document, in the present embodiment, is very straightforward. It can only contain tag names, attribute names, attribute values and data. It cannot contain comments, or DTD, or a Schema validation part.

The example, an XML document may have the following form:

```
<m2m>
  <servlet>
  <servlet-name>test 1</servlet-name>
  <servlet-class>test 2</servlet-class>
  <init-param>
  <param-name id=“0.1”>test 3</param-name>
  <param-value>test 4</param-value>
  <description name=“Thing”>test 5</description>
  </init-param>
  <load-on-startup>1</load-on-startup>
  </servlet>
  <foo>
  <bar>test 6</bar>
  <gservlet-class>test 7</gservlet-class>
  </foo>
</m2m>
```

### 4. The Module Concept

For the record, it should be remembered that most radiocommunication devices include, conventionally, a set of electronic components implanted on a printed circuit. The purpose of these different components is to provide the different necessary functions, from reception of an RF signal to the generation of an audible signal (in the case of a radio telephone), and vice versa. Some of these functions are analogue, and others digital.

The manufacture of these radiocommunication devices is a major research topic. Indeed, there are at least three target objectives which are difficult to reconcile: miniaturising the devices, increasing the functionalities and simplifying the assembly. It is known in particular that implanting different components on the printed circuit is a relatively complex operation, since many components have to be installed on an increasingly restricted surface area, given the requirements of miniaturisation.

The design of these systems is therefore complex, since it additionally means that miscellaneous components, often multiple sources, have to be associated which have to be made to operate together, while respecting the specificities of each. Furthermore, when all the components are assembled, calibration and test phases, which are often long and complex, are required in order to ensure that the device operates smoothly.

Finally, despite the reduction in the size of some components, the assembly takes up a certain surface area, which it is difficult to reduce.

The holder of the present patent application has proposed an approach that overcomes a certain number of these drawbacks, consisting in collecting into a single module, all, or at least most, of the functions of a digital radio communication device.

A module of this kind comes in the form of a single, compact and preferably armour-clad housing, which the manufacturers of devices can implant directly, without having to take account of a multitude of components. In other embodiments, the module can be split, for example over two elements preferentially interconnected by digital connections.

This module (still sometimes known as a “macro-component”) is indeed formed of a collection of several components on a substrate, so as to be implanted in the form of a single element. It includes the components and basic software necessary for the operation of a telecommunications terminal using radio frequencies. There are therefore no further complex stages in the design and validation thereof. All that needs to be done is to reserve the necessary space for the module.

A module of this kind therefore makes it possible to integrate all the components into wireless terminals (mobile telephones, modems, or any other application using a wireless standard) easily, rapidly and in an optimised way.

Furthermore, since it brings together all the essential functions which have been designed as a whole, problems of calibration and testing are no longer raised in the same way, or are at the very least greatly simplified.

Thus, the modules disseminated by the holder of the present patent application are fully tested as regards both hardware and software on most of the networks on which they may subsequently be used. Furthermore, the module encompasses to advantage the aspects of industrial property (with all the functions being collected together, it is the module manufacturer who manages the corresponding industrial property rights) and technical support.

### 5. AT Commands

The principle of implementing AT commands is already known. It is for example described in patent document FR-99 13645, and in the various specifications issued by the applicant, to which reference may be made for more detailed information, if necessary.

### 6. New AT Commands

This module 14 is able to manage a small number of simple AT commands allowing a straightforward and effective dialogue with an external application associated with a terminal. It converts data into the XML format and compresses it, and manages the sending and receiving of data 15 according to this protocol, in a transparent way for the application.

Data can therefore be exchanged by microwave 16, in accordance with the GPRS standard for example, or in the form of short messages (SMS). From the point of view of the server 12, the information is in the XML format. For the terminals 11, it is not necessary to know this protocol, but only a few AT commands. It is thus possible to implement an external application easily and inexpensively into (or next to) a terminal, without it being necessary to provide a microprocessor and memories, and a dedicated application.

As will be seen subsequently, the AT commands proposed can be limited in number to 8, while remaining expandable.

### 7. Buffer Memory Management

Two data transfer modes are proposed:
the data passes through the module 14. It is then stored temporarily in buffers, the size of which can be configured as a function of need;
the data is transmitted directly between the terminal and the server, without being stored in a memory in the module 14, the latter managing only all the signalling aspects (opening and closing the connection, verifications, etc.).

The first scenario may represent the most frequent scenario for small size messages, and the second for the transfer of large files. It is thus possible to manage everything through the module, without adding any external memory and intelligence, while allowing data to be transferred that is higher in volume than the storage capacity of the module.

To advantage, a single command makes it possible to size the buffers and to move from one mode to the other (the second mode corresponding to a nil value)

### 8. Example of Software Architecture

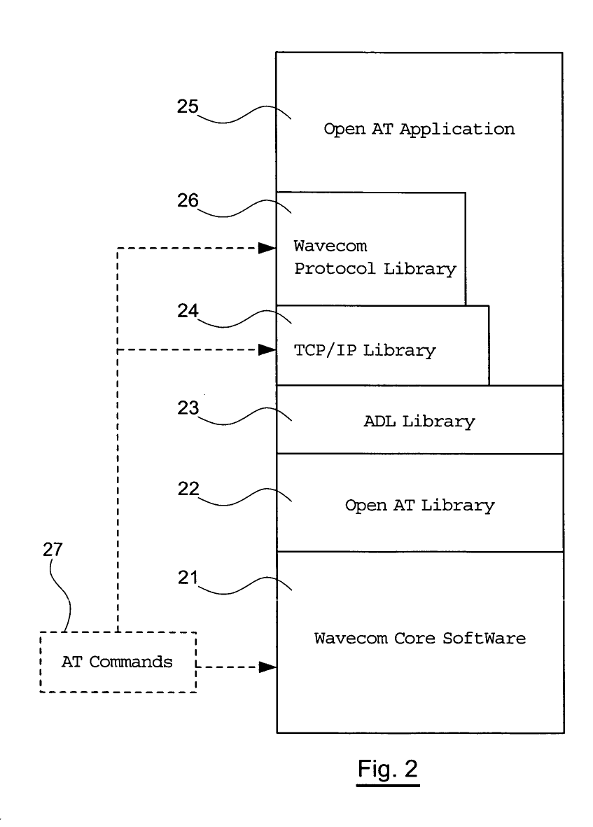

FIG. 2 shows a simplified example of software architecture that can be implemented in the module 14.

Such a module 14 generally comprises:
Wavecom Core SoftWare 21;
an Open AT Library 22;
an ADL Library 23;
a TCP/IP Library 24;
an Open AT Application 25.

According to an embodiment of the invention, further provision is therefore made for a library 26 of specific commands to communicate according to the given protocol, which is placed above the TCP/IP library 24.

The AT commands 27 are addressed, according to circumstances, to the Wavecom core 21, to the TCP/IP library 24 or to the specific library 26.

The interface by AT commands proposed includes in this library 26 includes only 8 commands, making it possible to fully use the protocol, and in particular to:
Configure the modem (bearer, WBXML tables etc.);
Outsource the management of large size XML pages;
Get connected to the M2M gateway;
Manage configuration parameters;
Send and receive XML pages by generic command;
Automatic mode to collect pages at the gateway and send a page saved in the module.
Easily handle XML pages exchanged with an M2M gateway (create and modify an XML page, “parse” (compress) a received page, search for a particular tag.

### 9. Detailed Description of One Command Embodiment

A description will be given hereinafter of AT commands that can be used to drive the given protocol 26.

### 10. Related Documents

If the need arises, reference may be made in particular to the following documents:

[1] The “Orange M2M Protocol Definition”, and particularly:
120-Orange M2M GPRS v8 Protocol Definition
120-Orange M2M SMS v4.0 Protocol Definition
120-Orange M2M SOAP v4.0 Protocol Definition
120-Orange M2M WBXML v3.0 Encoding Method

[2] Guide to the interface of reference Wavecom AT commands:
WM_ASW_OAT_UGD_{—}010 revision 3 or following. This document describes the AT commands handled by Wavecom products that allow events and services to be managed.

### 11. Abbreviations and Definitions

The following abbreviations are used hereinafter:
APN Access Point Name
DNS Domain Name System
GGSN GPRS gateway service node—Used by peripherals to establish network connections and by the proposed system to consult the IP address of MSISDN blocks known by all the SMSC for routing messages in both directions.
GPRS General Packet Radiocommunication System
GSM Global System for Mobile Communications.
ISP Internet Service Provider
M2M Machine to machine
ME Mobile Equipment
MS Mobile Station
MSISDN Mobile Station RNIS Number—Synonym of mobile telephone number.
NMTS “No more to send”
SI “Smart Integrator” integrated software.
SMPP Simple Mail Transfer Protocol. Used for communication with SMSC. Does not apply to the GPRS.
SMSC Short Message Server Centre.
WAP Wireless Application Protocol
WBXML WAP Binary Expandable Marker Language. Binary representation for WAP documents. In the context of the relay, the WAP will not be used, but the WBXML specification will nonetheless apply to standard XML documents.
XML Expandable Marker Language

The terms MS or ME are used for mobile terminals that handle GSM services.

The word “product” denotes any Wavecom product (in particular module) handling the AT command interface.

| | |
|---|---|
| <CR> | Carriage Return character |
| <LF> | Line Feed character |
| [ . . . ] | Optional AT command parameter |
| < . . . > | Parameter name put between chevrons. The chevrons do |
| | not appear in the command line. |

### 12. AT Command Syntax

A description is given hereinafter of the format of AT commands, and of the default value mechanisms in respect of the parameters thereof.

### Command Line

The commands always start with the standard “AT+M2M” prefix and end with the character <CR>.

The optional parameters are put between square brackets [ ].

Example: AT+M2MCmd=<Param1>[,<Param2>]

Here, <Param2> is optional. When the command AT+M2MCmd is executed without <param2>, the default value of <param2> is used.

### Information Responses and Result Codes

The responses start and end with <CR><LF> (except for the response format ATV0 DCE) and the commands ATQ1 (deletion of result code). (See document [2]).
If the command syntax is incorrect, the command is transmitted to the Wavecom core software for processing therein. In this event, the “ERROR” message is controlled by the WAVECOM core software.
If the command syntax is correct, but transmitted with incorrect parameters the string <CR><LF>+M2M ERROR: <Err><CR><LF> is sent with appropriate error codes.
If the command line has been successfully executed, a string <CR><LF>“OK”<CR><LF> is returned.

### Commands, Indications and Error Codes

Reference will be made to the attached appendix, which gives a detailed description of the commands implemented according to the present embodiment. This appendix contains the following elements:

Configuration Commands:
General parameters +M2MGSET
Connection Parameters +M2MCSET
Symbol Table Parameters WBXML +M2MWBXML

General Commands:
Connection Management +M2MCONM
Send a Message +M2MSM
Create or modify an XML message +M2MCM
Receive a message +M2MRM
Protocol Administration +M2MPA

M2M Indications:
Connection Indications+M2MCONI
Send Message Indications +M2MSMI
Receive Message Indications +M2MRMI
Analysis Message Indication +M2MPMI

Error Codes.

### EXAMPLE

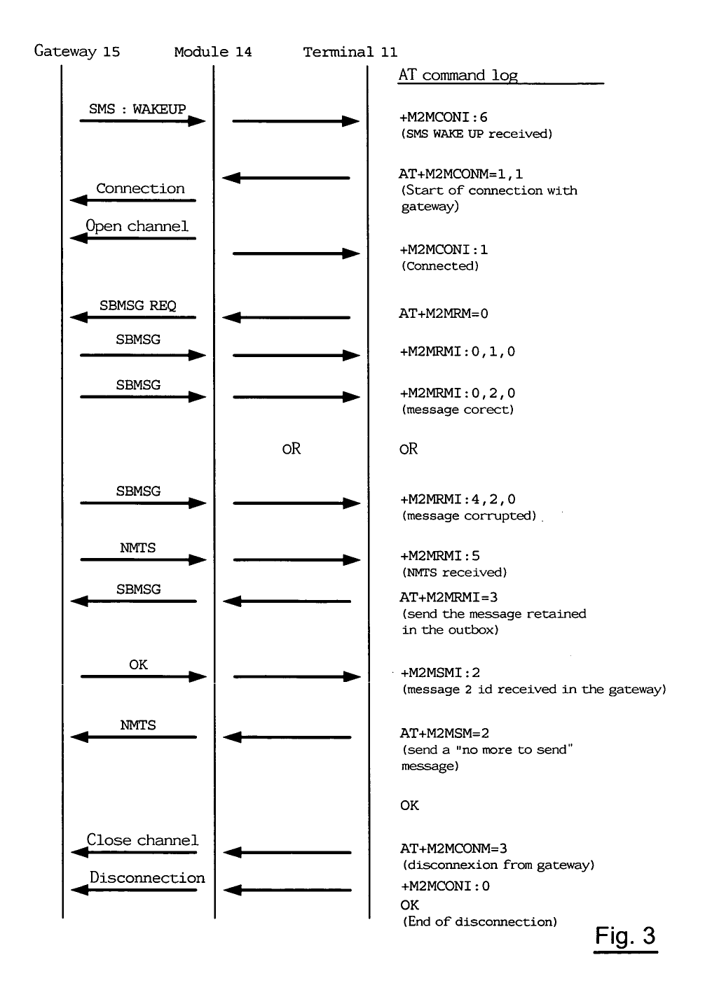

FIG. 3 shows, in the form of a sequential diagram, the implementation of AT commands of the protocol described above, in the event of a manual mode in-box.

In this figure, the information is presented in accordance with a formality which is customary for the man skilled in the art, giving an accurate picture of the data exchanges between the different entities (server, or broker, module and external application). The fourth column shows the commands used, and where necessary their significance.

It does not appear necessary to make any additional comment about these figures, which will be understood straightaway by the man skilled in the art.

### 13. Appendix

### Configuration Commands

Different parameters are required to give the Wavecom product all the information about the initial connection:
The support used: SMS or GPRS
The function mode of the Wavecom Orange M2M protocol array.
All support-related data to give access to a TCP/IP infrastructure

### 13.1 General Parameters +M2MGSET

### Description

This command makes it possible to configure all the parameters used to select the Wavecom Orange M2M protocol support and function mode.

### Syntax

| Commands | Possible Responses |
|---|---|
| AT+M2MGSET=<BearerSel>[,<NotifyLevel>[, | OK |
| <OutBoxSize>[,<InBoxSize>[,<RetainOutMessage>[, | Or |
| <AutomaticMode>[,<FetchMsgDelay>[, | Error Codes: |
| <RetryMsgCount>[,<M2Mwakeup>]]]]]]]] | +M2M ERROR: 4000 |
| Observation: configure or document | +M2M ERROR: 4001 |
| all general parameters | +M2M ERROR: 4002 |
| AT+M2MGSET? | +M2MGSET: |
| Observation: current parameters. | <BearerSel>[,<NotifyLevel>[,<OutBoxSize>[, |
| | <InBoxSize>[,<RetainOutMessage>[, |
| | <AutomaticMode>[,<FetchMsgDelay>[, |
| | <RetryMsgCount>[,<M2Mwakeup>]]]]]]]] |
| | OK |
| AT+M2MGSET=? | +M2MGSET: (0-1), (0-3), (0-32767), (0- |
| Observation: possible values | 32767), (0-1), (0-3), (1-32767), (0-10), |
| | (0-1) |
| | OK |
| AT+M2MGSET=0 | OK |
| Observation: configure the support | Observation: GPRS selected |
| AT+M2MGSET=,2 | OK |
| Observation: configure the | Observation: only message events are |
| <NotifyLevel> parameter | notified. |
| AT+M2MGSET=,,,,2 | +M2M ERROR: 4001 |
| Observation: configure the | Observation: unauthorised operation |
| <RetainOutMessage> parameter with | |
| an erroneous value | |
| AT+M2MGSET? | +M2MGSET: 0,3,512,32767,0,0,600,0,1 |
| Observation: read all current values | OK |
| AT+M2MGSET=? | +M2MGSET: (0-1), (0-3), (0-32767), (0- |
| Observation: possible values | 32767), (0-1), (0-3), (1-32767), (0-10), |
| | (0-1) |
| | OK |

### Specified Values

| Parameter | | | Default |
|---|---|---|---|
| name | Description | Specifications | value |
| <BearerSel> | SMS/GPRS selection | (0-1) | 0 |
| | | 1: SMS (the MSISDN | |
| | | parameters are used for a | |
| | | connection) | |
| | | 0 GPRS (the APN and | |
| | | TCP port parameters are | |
| | | used for a connection) | |
| <NotifyLevel> | Indication level for all | (0-3) | 3 |
| | events related to | 0 No notification | |
| | connections and/or | 1 Notify connection | |
| | messages such as | events. | |
| | unsolicited responses (see | 2 Notify message | |
| | section on M2M | events | |
| | indications). | 3 Notify all events. | |
| <OutBoxSize> | Size in bytes of the buffer | (0-32767) | 32767 |
| | and outbox | 0: the message cannot | |
| | There can only be one | be retained and is processed | |
| | message at a time in the | directly: the AT command | |
| | outbox buffer. | is free after the message is | |
| | If the outbox contains a | sent. | |
| | message when the | 1-32767: the AT | |
| | OutBoxSize parameter is | command is directly free | |
| | modified, this message is | and the message to be sent | |
| | lost. | is stored, awaiting the send | |
| | The outbox is registered | sequence. | |
| | in the flash memory. | | |
| <InBoxSize> | Size in bytes of the inbox | (0-32767) | 32767 |
| | queue | 0: all messages received | |
| | The number of messages | are automatically sent to | |
| | stored in the buffer | the external application. | |
| | depends on the size of | Output ended with <Ctrl- | |
| | each message. | P><Ctrl-C>, in uncoded | |
| | If the outbox contains | XML text (if the source is in | |
| | messages when the | WBXML, decoding is | |
| | OutBoxSize parameter is | automatic). | |
| | modified, these messages | 1-32767: messages | |
| | are lost. | received are stored. The | |
| | The inbox is registered in | external application must | |
| | the flash memory. | retrieve them manually. | |
| <RetainOutMessage> | The message in the output | (0-1) | 0 |
| | buffer is retained after it | 0: the buffer is free | |
| | has been sent to the | after the message is sent to | |
| | gateway. | the gateway | |
| | | 1: the message is | |
| | | retained after it is sent | |
| <AutomaticMode> | Operating Mode | 0: Manual mode | 0 |
| | | 1: Automatic mode | |
| | | 2: Input | |
| | | Automatic/Output Manual | |
| | | 3: Input Manual/Output | |
| | | Automatic | |
| | | (see details below) | |
| <FetchMsgDelay> | The minimum number of | (1-32767) | 600 |
| | seconds between the | | |
| | automatic handling of | | |
| | messages from the | | |
| | gateway: for | | |
| | <AutomaticMode> 1 and 2 | | |
| <RetryMsgCount> | Number of failed attempts | (0-10) | 0 |
| | to send a message before | | |
| | the send attempt activity | | |
| | is cancelled. Only if the | | |
| | GPRS support is used. | | |
| <M2Mwakeup> | Configures the SMS | (0-1) | 1 |
| | wake-up service | 0: disabled | |
| | | 1: activated | |

### Details About the <Automatic Mode> Parameter:

Manual mode: the service is controlled via the serial link using intervention commands. On receipt of an SMS wake-up call, a +M2MCONNI message is sent to the serial link to inform the remote application that the event has taken place. The driver must initiate an exchange transaction using intervention commands to send and receive messages.
Automatic mode: the service manages the exchange transaction with the M2M gateway autonomously using the <Fetch Message Delay> parameter. On receipt of a wake-up SMS, an exchange starts up immediately.
Input automatic/Output manual mode: incoming messages are processed automatically using the <Fetch Message Delay> parameter. No automatic outgoing XML message creation occurs.
Input manual/Output automatic mode: the outgoing message is automatically generated (if the output buffer contains a retained message which has been modified since the last send) and sent to the gateway using the <Fetch Message Delay> parameter. No automatic handling of incoming messages.

### Possible Error Codes

| | |
|---|---|
| +M2M ERROR: 4000 | The Wavecom Orange M2M protocol |
| | function is not activated. This error is |
| | returned when the Wavecom Orange M2M |
| | protocol function has not been activated in |
| | the WISMO module. |
| +M2M ERROR: 4001 | Operation denied. This error is returned |
| | when an erroneous parameter is detected. |
| +M2M ERROR: 4002 | Operation not supported by the current |
| | configuration (in the connection). |

### 13.2 Connection Parameters +M2MCSET

### Description

This command is used to configure all the parameters associated with connection to the Wavecom Orange M2M protocol.

### Syntax

| Commands | Possible Responses |
|---|---|
| AT+M2MCSET=<OMSISDN>[,<DMSISDN>[, | OK |
| <APN>[,<UserName>,[<Password>[, | +M2M ERROR: 4000 |
| <IpAddress>[,<SocketPort>]]]]]] | +M2M ERROR: 4001 |
| Observation: configure all connection | |
| parameters | |
| AT+M2MCSET? | +M2MCSET: <OMSISDN>, |
| Observation: current parameter values | <DMSISDN>, <APN>, <UserName>, |
| | <Password>, <IpAddress>, |
| | <SocketPort> |
| | OK |
| AT+M2MCSET=? | OK |
| Observation: possible values | |
| AT+M2MCSET=”+33612214629”, | OK |
| ”+33612214610”,”m2m.orange”,”myuser | Observation: new stored parameters |
| name”,”mypassword”,”1.2.3.4”,”1024” | |
| Observation: configure all parameters | |
| AT+M2MCSET=,,,,,”1.2.3.4”,”1024” | OK |
| Observation: configure only the IP | Observation: new stored parameters |
| address and port parameters | |
| AT+M2MCSET=”+33612214629”, | +M2M ERROR: 4001 |
| ”+33612214610”,”m2m.orange”,”myuser | Observation: unauthorised operation |
| name”,”mypassword”,”0.0.0.0”,”1024” | |
| Observation: configure all ISP | |
| parameters with an erroneous | |
| parameter (IP address) | |
| AT+M2MCSET? | +M2MCSET: “+33612214629” |
| Observation: current values | ,“+33612214610”,”m2m.orange”,”myuser |
| | name”, |
| | ”mypassword”, “1.2.3.4”,”1024” |
| | OK |
| | Observation: range of stored values |
| AT+M2MCSET=? | OK |
| Observation: possible values | Observation: values handled |

### Specified Values

The following parameters are used for the two SMS and GPRS supports.

| Context | | | | Default |
|---|---|---|---|---|
| Parameter | Description | Format | Specifications | value |
| <OMSISDN> | RNIS of the | Alphanumeric | Max. length = | “” |
| | mobile | string | 32 | |
| | station | | | |
| | (basis for the | | | |
| | telephone | | | |
| | number). | | | |
| <DMSISDN> | Targer RNIS | Alphanumeric | Max. Length = | “” |
| | of the M2M | string | 32 | |
| | gateway | | | |

The following parameters are used when the GPRS support is selected. See also the “other parameters” section.

| Context | | | | Default |
|---|---|---|---|---|
| parameter | Description | Format | Specifications | value |
| <APN> | APN coming | Alpha- | Max. Length = | “” |
| | from the ISP | numeric | 64 | |
| | to provide | string | | |
| | GPRS access | | | |
| <Username> | APN user name | Alpha- | Max. Length = | “” |
| | coming from | numeric | 32 | |
| | the ISP to | string | | |
| | provide | | | |
| | GPRS access. | | | |
| <Password> | APN password | Alpha- | Max. Length = | “” |
| | coming from | numeric | 32 | |
| | the ISP to | string | | |
| | provide | | | |
| | GPRS access. | | | |
| <IpAddress> | IP address of | Alpha- | Max. Length = | “” |
| | the gateway | numeric | 120 | |
| | | string | | |
| <SocketPort> | Gateway port | Alpha- | Max. Length = | “” |
| | used with the | numeric | Numbers larger | |
| | connection | string | than 65 535 are | |
| | | | denied. | |

### Possible Error Codes

| | |
|---|---|
| +M2M ERROR: 4000 | The Wavecom Orange M2M protocol |
| | function is not activated. This error is |
| | returned when the Wavecom Orange M2M |
| | protocol function has not been activated in |
| | the WISMO module. |
| +M2M ERROR: 4001 | Operation denied. This error is returned |
| | when an erroneous parameter is detected. |
| +M2M ERROR: 4002 | Operation not supported by the current |
| | configuration (in the connection). |

### 13.3 WBXML +M2MWBXML Symbol Table Parameters

### Description

This command allows the known symbol table to be configured for the WBXML syntactic analyser. This operation can only be performed if the service is not connected.

### Syntax

| Command | Possible responses |
|---|---|
| AT+M2MWBXML=<Type>, | OK |
| <Param1>[,<Param2>[, | or |
| <Pparama3>,[...]]]]<CR> | Error Codes: |
| Observation: configure a part of the | +M2M ERROR: 4000 |
| known symbol table. | +M2M ERROR: 4001 |
| | +M2M ERROR: 4002 |
| | +M2M ERROR: 4003 |
| AT+M2MWBXML? | +M2MWBXML: |
| Observation: return the configured | 0,<Param1>,<Param2>,... |
| symbol table | +M2MWBXML: |
| | 1,<Param1>,<Param2>,... |
| | +M2MWBXML: |
| | 2,<Param1>,<Param2>,... |
| | OK |
| AT+M2MWBXML=? | +M2MWBXML: (0-2) |
| Observation: possible values | OK |
| AT+M2MWBXML=1,”id”,”name” | OK |
| Observation: enter the attribute name | |
| data | |
| AT+M2MWBXML= 2,0.1,Thing | +M2M ERROR: 4001 |
| Observation: enter the attribute value | Observation: unauthorised |
| information with erroneous | operation |
| parameters | |
| AT+M2MWBXML? | +M2MWBXML: 0,”servlet- |
| Observation: read all configured | name”,”servlet”,”servlet-class” |
| values | +M2MWBXML: 1,”id”,”name” |
| | +M2MWBXML:2,”0.1”,”Thing” |
| | OK |
| AT+M2MWBXML=? | +M2MWBXML: (0-2) |
| Observation: possible values | OK |

### Specified Values

| | |
|---|---|
| <Type> | (0-2) Type of specified values |
| 0 | Specifies the list of indicators used by WBXML for |
| | encoding/decoding XML messages |
| 1 | Specifies the list of attribute names used by WBXML for |
| | encoding/decoding XML messages |
| 2 | Specifies the list of attribute values used by WBXML for |
| | encoding/decoding XML messages. One-to-one mapping |
| | must be established between the attribute name values and |
| | parameters. |
| <Param n> | Indicators, attribute name or attribute value. |

### Observation

To reinitialise each list, simply enter the type without any list. So, to reinitialise the symbol table, merely enter the following commands:
AT+M2MWBXML=0 (reinitialises the list of symbol table indicators)
AT+M2MWBXML=1 (reinitialises the list of symbol table attributes)
AT+M2MWBXML=2 (reinitialises the list of symbol table values)

### Possible Error Codes

| | |
|---|---|
| +M2M ERROR: 4000 | The Wavecom Orange M2M protocol |
| | function is not activated. This error is |
| | returned whether Wavecom Orange M2M |
| | protocol function has not been activated in |
| | the WISMO module. |
| +M2M ERROR: 4001 | Operation denied. This error is returned |
| | when an erroneous parameter is detected. |
| +M2M ERROR: 4002 | Operation not supported by the current |
| | configuration |
| +M2M ERROR: 4003 | Service already connected. |

### 13.4 General Commands

### 13.4.1 Connection Management +M2MCONM

### Description

This command makes it possible to manage the connection to a M2M gateway.

### Syntax

| Command | Possible Responses |
|---|---|
| AT+M2MCONM=<Mode>[, | OK |
| <CleanDisconnect>,[<ForcedAcknowledge>]] | Or |
| Observation: connection/disconnection | Error Codes: |
| operations | +M2M ERROR: 4000 |
| | +M2M ERROR: 4001 |
| | +M2M ERROR: 4002 |
| | ... |
| | +M2M ERROR: 4009 |
| AT+M2MCONM? | +M2MCONM: <Status> |
| Observation: return the connection | OK |
| status | |
| AT+M2MCONM=? | +M2MCONM: (list of <Mode> |
| Observation: possible values | handled), (list of <CleanDisconnect> |
| | handled), (list of <ForcedAcknowledge> |
| | handled) |
| | OK |
| AT+M2MCONM? | +M2MCONM: 0 |
| Observation: obtain current connection | OK |
| status | Observation: the module is not |
| | connected to the gateway |
| AT+M2MCONM=1,,1 | OK |
| | +M2MCONI: 1 |
| | Observation: connection operation |
| | launched with the ForcedAcknowledge |
| | parameter activated mode |
| AT+M2MCONM? | +M2MCONM: 2 |
| Observation: obtain current connection | OK |
| status | Observation: connection operation |
| | pending |
| AT+M2MCONM=1 | +M2M ERROR: 4003 |
| Observation: another connection is | Observation: operation not handled |
| requested | |
| AT+M2MCONM? | +M2MCONM: 1 |
| Observation: obtain current connection | OK |
| status | Observation: the connection is |
| | established with the gateway |
| AT+M2MCONM=2, 0 | OK |
| Observation: disconnection with queue | +M2MCONI: 0 |
| reset | |
| AT+M2MCONM=? | +M2MCONM: (0-1),(0-1),(0-1) |
| Observation: possible values | OK |

### Specified Values

| | |
|---|---|
| <Mode> | (0-2) |
| | 0: disconnection from a Wavecom Orange M2M protocol |
| | active session |
| | 1: connection to the remote M2M gateway (support |
| | activated, but the start of transaction depends on the automatic |
| | mode parameter; see 3.1). |
| | 2: cancellation of connection, only if the connection is |
| | pending. |
| <CleanDisconnect> | (0-1) Disconnect Mode. (default value = 1) |
| | 0: disconnection begins immediately, the queue is |
| | emptied and all outgoing transactions are deleted. |
| | 1: all queuing messages (waiting or pending) are |
| | processed prior to disconnection. |
| <ForcedAcknowledge> | If the size of an incoming message exceeds the |
| | maximum size of the queue, this parameter forces the |
| | library to send acknowledgements of receipt for such |
| | messages to the message gateway, even if they have not |
| | actually been received. |
| | 0: the mode is disabled |
| | 1: the mode is activated (default value) |
| <Status> | (0-3) Status of connection with the gateway |
| | 0: not connected |
| | 1: connected |
| | 2: connection pending |
| | 3: disconnection |

### Possible Error Codes

| | |
|---|---|
| +M2M ERROR: 4000 | The Wavecom Orange M2M protocol |
| | function is not activated. This error is |
| | returned when the Wavecom Orange M2M |
| | protocol function has not been activated in |
| | the WISMO module. |
| +M2M ERROR: 4001 | Operation denied. This error is returned |
| | where an erroneous parameter is detected. |
| +M2M ERROR: 4003 | Customer already connected |
| +M2M ERROR: 4004 | Connection operation pending |
| +M2M ERROR: 4005 | Disconnection operation pending |
| +M2M ERROR: 4006 | Customer not connected. This error is |
| | returned when a disconnection is requested |
| | when the ME is not connected. |
| +M2M ERROR: 4007 | No network |
| +M2M ERROR: 4008 | No GPRS |
| +M2M ERROR: 4009 | No TCP/IP |

### 13.4.2 Send Message +M2MSM

### Description

This command allows XML messages or a No More To Send message to be sent or the status of these messages to be obtained.

This command is used in “manual mode” or “automatic mode” if no “stored page” is specified (see 3.1) and after an M2M connection.

### Syntax

| Command | Possible Responses |
|---|---|
| AT+M2MSM=<ActionType>>[, | When a message is sent |
| <ReplyID>[,<WBXML mode>]] | +M2MSM: <MsgId> |
| Observation: configure the parameter | OK |
| of all messages | or |
| | when a message status is requested |
| | +M2MSM: <Status> |
| | OK |
| | or |
| | Error Codes: |
| | +M2M ERROR: 4000 |
| | +M2M ERROR: 4001 |
| | +M2M ERROR: 4006 |
| | +M2M ERROR: 4010 |
| | +M2M ERROR: 4012 |
| | +M2M ERROR: 4013 |
| | +M2M ERROR: 4014 |
| | +M2M ERROR: 4015 |
| AT+M2MSM? | OK |
| Observation: no effet | |
| AT+M2MSM=? | +M2MSM: (list of <ActionType> |
| Observation: possible values | handled) |
| | OK |
| AT+M2MSM=0 | > |
| Observation: send an uncoded XML | Observation: wait for the end of |
| text message | the uncoded XML text page by |
| | <ctrl>P<ctrl>C |
| <m2m> | +M2MSM: 1 |
| <servlet> | OK |
| <servlet-name>test 1</servlet-name> | Observation: the message is in the |
| <servlet-class>test 2</servlet-class> | output buffer or is sent. |
| <init-param> | When the stored page parameter |
| <param-name id=“0.1”>test | (see 3.1) is specified, the page is |
| 3</param-name> | retained. In automatic mode, the |
| <param-value>test 4</param-value> | page is only returned if it |
| <description name=“Thing”>test | has been modified. |
| 5</description> | |
| </init-param> | |
| <load-on-startup>1</load-on- | |
| startup> | |
| </servlet> | |
| <foo> | |
| <bar>test 6</bar> | |
| <gservlet-class>test 7</gservlet- | |
| class> | |
| </foo> | |
| </m2m> | |
| <ctrl>P<ctrl>C | |
| Observation: useful data | |
| AT+M2MSM=2 | +M2MSM: W |
| Observation: obtain the status of the | OK |
| last input message | Observation: message in queue |
| AT+M2MSM=3 | OK |
| Observation: send a No More To | |
| Send message | |
| AT+M2MSM=4 | OK |
| Observation: return the retained | |
| message | |
| | +M2MSMI: 2 |
| | Observation: message 2 id received |
| AT+M2MSM? | OK |
| AT+M2MSM=? | +M2MSM: (0-2) |
| Observation: possible values | OK |

Observation: It is possible to quit a command <strl-P> in the text by <ctrl-P><ctrl-P>.

### Specified Values

| | |
|---|---|
| <ActionType> | Type of operation |
| | 0: enter and send a message |
| | 1: enter and send a solicited message (SMS only) |
| | 2: obtain the status of the last input message |
| | 3: send a “No More To Send” message to the |
| | gateway |
| | 4: return the stored XML message |
| | 5: delete the stored XML page |
| <ReplyID> | For a solicited message only (i.e., ActionType==1), |
| | reference of the message from the original M2M |
| | gateway to the peripheral. Only for the compressed |
| | WBXML message to be sent to the SMS support |
| <WBXML Mode> | 0: the WBXML syntactic analyser is not used |
| | (the message is sent in uncoded text) |
| | 1: the WBXML syntactic analyser is used with the |
| | known symbol table, if it is specified (default value) |
| | 2: the WBXML syntactic analyser is used and the |
| | WBXML syntactic analyser will generate the |
| | compression table and insert it into the message. |
| <Status> | Message status |
| | W: WAITING. The message is in the queue, the |
| | transaction has not started and the message is |
| | retained. P: PENDING. The message is in the |
| | queue. The transaction is underway. |
| | N: message not found. The message is not in the |
| | queue. Either the transaction is finished, or the |
| | message has never been queued. |

### Possible Error Codes

| | |
|---|---|
| +M2M ERROR: 4000 | The Wavecom Orange M2M protocol |
| | function is not activated. This error is |
| | returned when the Wavecom Orange M2M |
| | protocol function has not been activated in |
| | the WISMO module. |
| +M2M ERROR: 4001 | Operation denied. This error is returned |
| | when an erroneous parameter is detected. |
| +M2M ERROR: 4002 | Operation not supported by the current |
| | configuration. |
| +M2M ERROR: 4006 | Customer not connected |
| +M2M ERROR: 4010 | Buffer SATURATED: a page is stored in the |
| | output buffer or an XML page (see 4.3) is |
| | currently being created. |
| +M2M ERROR: 4012 | The uncoded XML text message is too long |
| | in SMS |
| +M2M ERROR: 4013 | No message solicited in GPRS. |
| +M2M ERROR: 4014 | The solicited message is not compressed by |
| | WBXML. |
| +M2M ERROR: 4015 | No message in the queue. |

### 13.4.3 XML Message Creation or Modification +M2MCM

### Description

This command allows an uncoded XML text message to be created or easily modified (if the retaining parameter is specified; see 3.1) in the output buffer.

At the end of creation, the message is automatically sent.

This command is used in “manual mode” or in “automatic mode” if no “stored page” is specified (see 3.1) and after an M2M connection.

### Syntax

| Command | Possible Responses |
|---|---|
| AT+M2MCM=<ActionType>, | At the end of creation, when the |
| [<param1>, | message is sent |
| 1>,[<param2>,[<param3>]]] | +M2MCM: <MsgId> |
| Observation: create an XML message | OK |
| | or |
| | Error codes: |
| | +M2M ERROR: 4000 |
| | +M2M ERROR: 4001 |
| | +M2M ERROR: 4006 |
| | +M2M ERROR: 4010 |
| | +M2M ERROR: 4012 |
| | +M2M ERROR: 4013 |
| | +M2M ERROR: 4014 |
| | +M2M ERROR: 4016 |
| | +M2M ERROR: 4017 |
| | +M2M ERROR: 4019 |
| | +M2M ERROR: 4020 |
| AT+M2MCM? | OK |
| Observation: no effect | |
| AT+M2MCM=? | +M2MCM: (list of |
| Note: Possible values | <ActionType> handled) |
| | OK |
| AT+M2MCM=1,1 | OK |
| Observation: start creating an XML | |
| message in the output buffer using the | |
| WBXML syntactic analyser with the | |
| known symbol table. | |
| AT+M2MCM=2,”m2m” | OK |
| Observation: write a start indicator | OK |
| AT+M2MCM=2,”servlet” | OK |
| AT+M2MCM=2,”servlet-name” | OK |
| AT+M2MCM=4,”test 1” | OK |
| Observation: write a data item | OK |
| AT+M2MCM=5,”servlet-name” | OK |
| Observation: write an end indicator | OK |
| AT+M2MCM=2,”servlet-class” | OK |
| AT+M2MCM=4,”test 2” | OK |
| AT+M2MCM=5,”servlet-class” | OK |
| AT+M2MCM=2,”init-param” | OK |
| AT+M2MCM=2,”param-name” | OK |
| AT+M2MCM=3,”id”,“0.1” | OK |
| AT+M2MCM=4,”test 3” | OK |
| AT+M2MCM=5,”param-name” | +M2MSMI: 0 |
| AT+M2MCM=5,”init-param” | OK |
| AT+M2MCM=5,”servlet” | Observation: the message is in |
| AT+M2MCM=5,”m2m” | the output buffer or is sent. |
| AT+M2MCM=6 | When the stored page parameter |
| Observation: end of page creation | (see 3.1) is specified, the page is |
| The input page is: | retained. In automatic mode, the |
| <m2m> | page is only returned if it has |
| <servlet> | been modified. |
| <servlet-name>test 1</servlet-name> | |
| <servlet-class>test 2</servlet-class> | |
| <init-param> | |
| <param-name id=“0.1”>test | |
| 3</param-name> | |
| </init-param> | |
| </servlet> | |
| <m2m> | |
| AT+M2MCM=8,”servlet-name”,”New | OK |
| data” | Observation: message in the |
| Observation: modify the data associated | output buffer modified |
| with the “servlet-name” indicator in the | |
| XML page retained in the output buffer | |
| AT+M2MCM=7,”init-param”,”param- | OK |
| name id”,“10” | |
| Observation: modify the value of the | |
| “param-name id” attribute, associated | |
| with the “init-param” indicator in the | |
| XML page retained in the output buffer | |
| AT+M2MSM=3 | OK |
| Observation: return the retained | |
| message | |
| AT+M2MCM? | OK |
| AT+M2MCM=? | +M2MCM: (0-8) |
| Observation: possible values | OK |

### Specified Values

| | |
|---|---|
| <ActionType> | Type of operation |
| | 1: start creating an XML message in the output buffer |
| | 2: write a start indicator |
| | 3: write an attribute |
| | 4: write data |
| | 5: write an end indicator |
| | 6: end a page setup |
| | 7: modify an attribute value of a retained page |
| | 8: modify a data value of a retained page |
| | Observation: in the event of a modification request |
| | (ActionType 7 and 8), if the size of the new value is |
| | different from the value it replaces, the following parts |
| | of the XML message will be displaced, only if enough |
| | room remains in the buffer; otherwise, an error code |
| | is generated. |
| <Param 1> | if <ActionType> = 1: |
| | 0: the WBXML syntactic analyser is not used |
| | (the message is sent in the form of uncoded text). |
| | 1: the WBXML syntactic analyser is used with |
| | the known symbol table, if it is specified. |
| | 2: the WBXML syntactic analyser is used and |
| | the WBXML syntactic analyser will generate the |
| | compression table and insert it into the message. |
| | if <ActionType> = 2: the start indicator name |
| | if <ActionType> = 3: the attribute name |
| | if <ActionType> = 4: the data value |
| | if <ActionType> = 5: the end indicator name |
| | if <ActionType> = 7: the indicator name associated with |
| | the modified attribute |
| | if <ActionType> = 8: the indicator name associated with |
| | the modified data. |
| <Param 2> | if <ActionType> = 1: if it exists, this is the message |
| | reference for the original M2M gateway message |
| | requesting a response. The message created is thus |
| | a solicited message (in other words the response). |
| | if <ActionType> = 3: the attribute value |
| | if <ActionType> = 7: the modified attribute name |
| | if <ActionType> = 8: the value of the new data |
| <Param 3> | if <ActionType> = 7: the value of the new attribute |

### Possible Error Codes

| | |
|---|---|
| +M2M ERROR: 4000 | The Wavecom Orange M2M protocol |
| | function is not activated. This error is |
| | returned when the Wavecom Orange M2M |
| | protocol function has not been activated in |
| | the WISMO module. |
| +M2M ERROR: 4001 | Operation denied. This error is returned |
| | when an erroneous parameter is detected or |
| | if the output buffer contains no stored page |
| | in the event of a modification request |
| | ((<Action Type 7 and 8>) or if <Action Type |
| | 1> has not been called up prior to the |
| | <Action Type 2 to 6> request or in the event |
| | of an (<Action Type 7 and 8>) modification |
| | request if the size of the new value is |
| | different from that of the value it replaces, |
| | the following parts of the document will be |
| | displaced, only if enough room remains in |
| | the buffer; otherwise, this error is generated. |
| +M2M ERROR: 4002 | Operation not supported by the current |
| | configuration. |
| +M2M ERROR: 4006 | Customer not connected |
| +M2M ERROR: 4010 | Buffer SATURATED: the output buffer |
| | already contains a stored page or an XML |
| | page is currently being created. |
| +M2M ERROR: 4012 | Uncoded XML text message too long in |
| | SMS |
| +M2M ERROR: 4013 | No message solicited in GPRS. |
| +M2M ERROR: 4014 | Message solicited not compressed by |
| | WBXML |
| +M2M ERROR: 4016 | Indicator cannot be found in the input buffer. |
| +M2M ERROR: 4017 | Error during syntactic analysis in the output |
| | buffer (violation of XML rules or memory |
| | allocation failure). |
| +M2M ERROR: 4019 | Modification of XML document impossible |
| | since it is currently being created. |
| +M2M ERROR: 4020 | XML document fully created (in other words |
| | the root element is closed). Try modification |
| | operations (ActionType 7 or 8). |

### 13.4.4 Receive Message +M2MRM

### Description

This command allows all actions relating to received messages to be performed: receiving, reading and analyzing.

A received message generates a +M2MRMI indication.

The peripheral requests the download of any incoming message waiting to be collected at gateway level. This AT command makes it possible to obtain messages that have reached the inbox queue.

This AT command is only available if the value 0 is not assigned to the <InboxSize> parameter (See general parameter command +M2MGSET). If the size of the inbox is set at 0, the messages will be displayed as an uncoded +M2MRMI text indication.

This AT command also allows a received message to be analysed. In this case, indicators, attributes and data are displayed as +M2MPM indications.

Finally, this AT command allows the value of an attribute or of the data in a received message to be read directly.

### Syntax

| Command | Possible Responses |
|---|---|
| AT+M2MRM=<ActionType>,[<param1>, | OK |
| [<param2>,[<param3>]]] | Or |
| | Error Codes: |
| | +M2M ERROR: 4000 |
| | +M2M ERROR: 4001 |
| | +M2M ERROR: 4002 |
| | +M2M ERROR: 4006 |
| | +M2M ERROR: 4010 |
| | +M2M ERROR: 4011 |
| | +M2M ERROR: 4016 |
| | +M2M ERROR: 4017 |
| | +M2M ERROR: 4018 |
| AT+M2MRM? | +M2MRM:<MsgId1> |
| Observation: return the list of | .... |
| messages in the inbox queue | +M2MRM: <MsgIdn> |
| | OK |
| AT+M2MRM=? | +M2MRM: list of <ActionType> handled |
| Observation: possible values | OK |
| AT+M2MRM? | +M2MRM: 8 |
| Observation: obtain the list of | OK |
| messages in the inbox queue | Observation: the inbox contains a message |
| AT+M2MRM=8,8 | +M2M ERROR: 4001 |
| Observation: obtain the message | Observation: unauthorised operation |
| with an erroneous <ActionType> | |
| parameter | |
| AT+M2MRM=1,8 | <m2m> |
| Observation: read the message 8 id | <servlet> |
| in the inbox queue. | <servlet-name>test 1</servlet-name> |
| | <servlet-class>test 2</servlet-class> |
| | <init-param> |
| | <param-name id=“0.1”>test 3</param- |
| | name> |
| | </init-param> |
| | </servlet> |
| | </m2m> |
| | <CR><LF>OK |
| AT+M2MRM? | OK |
| Observation: obtain the list of | Observation: the inbox contains no message |
| messages in the inbox queue | |
| AT+M2MRM=1,8 | +M2M ERROR: 4011 |
| Observation: obtain the message | Observation: message cannot be found |
| with the associated header | |
| AT+M2MRM=0 | OK |
| Observation: request the | +M2MRMI: 0,1,0 |
| downloading of all incoming | +M2MRMI: 0,2,0 |
| messages | +M2MRMI: 0,3,0 |
| | +M2MRMI: 5 |
| | Observation: three messages received and |
| | present in the inbox |
| AT+M2MRM=? | +M2MRM: (0-5) |
| Observation: possible values | OK |
| AT+M2MRM=2,1,”param- | 0.1 |
| name”,”id” | <CR><LF>OK |
| Observation: obtain an attribute | |
| value of message 1 | |
| AT+M2MRM=3,1,”servlet-name” | test 1 |
| Observation: obtain a data value of | <CR><LF>OK |
| message 1 | |
| AT+M2MRM=4,1 | OK |
| Observation: analyse message 1 | +M2MPMI: 1,”m2m” |
| | Observation: analyse the start |
| | indicator |
| | +M2MPMI: 1,”servlet” |
| | +M2MPMI: 1,”servlet-name” |
| | +M2MPMI: 3,”test 1” |
| | Observation: analyse the data |
| | +M2MPMI: 4,”servlet-name” |
| | Observation: analyse the end indicator |
| | +M2MPMI: 1,”servlet-class” |
| | +M2MPMI: 3,”test 2” |
| | +M2MPMI: 4,”servlet-class” |
| | +M2MPMI: 1,”init-param” |
| | +M2MPMI: 1,”param-name” |
| | +M2MPMI: 2,”id”,“0.1” |
| | +M2MPMI: 3,”test 3” |
| | +M2MPMI: 4,”param-name” |
| | +M2MPMI: 4,”init-param” |
| | +M2MPMI: 4,”servlet” |
| | +M2MPMI: 4,”m2m” |
| | +M2MPMI: 5 |
| | Observation: the message is finished |
| AT+M2MRM=5,1 | OK |
| Observation: delete message 1 from | |
| the inbox queue | |

### Specified Values

| | |
|---|---|
| <ActionType> | Type of operation |
| | 0: request the downloading of any incoming message |
| | awaiting collection at gateway level (the customer must |
| | first be connected). Manual mode only |
| | 1: obtain the uncoded <MsgId> text message and delete |
| | it from the inbox queue. |
| | 2: obtain an attribute value of the <MsgId> message. |
| | 3: obtain the value of the data in the <MsgId> message. |
| | 4: analyse the <MsgId> message. In this case, |
| | +M2MPMI messages are sent. |
| | 5: delete the <MsgId> message. |
| <Param 1> | with <ActionType> 1, 2, 3, 4 and 5>, <MsgId> |
| | parameter |
| <Param 2> | with <ActionType> 2 and 3>, indicator name to be found |
| | in the XML <MsgId>. Only the first occurrence is |
| | handled. |
| <param 3> | with <ActionType> 2, attribute name to be found. |

### Observation

If a message is encoded in WBXML and cannot be decoded because of an error, the gateway acknowledges the message, and the message is then deleted from the inbox queue. In this event, +M2MRMI indication: 4 is sent.

If the size of an incoming message is greater than the maximum size of the queue and if the <ForcedAcknowledge> parameter is activated (ON), the library sends acknowledgement of receipt of such messages to the message gateway, even if they have not actually been received. In this event, +M2MRMI indication: 3 is sent.

### Possible Error Codes

| | |
|---|---|
| +M2M ERROR: 4000 | The Wavecom Orange M2M protocol |
| | function is not activated. This error is |
| | returned when the Wavecom Orange M2M |
| | protocol function has not been activated in |
| | the WISMO module. |
| +M2M ERROR: 4001 | Operation denied. This error is returned |
| | when an erroneous parameter is detected. |
| +M2M ERROR: 4002 | Operation not supported by the current |
| | configuration. |
| +M2M ERROR: 4006 | Customer not connected |
| +M2M ERROR: 4010 | Input buffer SATURATED: the input |
| | buffer contains too many stored pages. |
| +M2M ERROR: 4011 | Message requested cannot be found in the |
| | input buffer |
| +M2M ERROR: 4016 | Indicator cannot be found in the input |
| | buffer. |
| +M2M ERROR: 4017 | Error during analysis of input buffer |
| | (violation of XML rules or memory |
| | allocation failure). |
| +M2M ERROR: 4018 | Attribute cannot be found in the input |
| | buffer. |

### 13.4.5 Administration of +M2MPA Protocol

### Description

This command makes it possible to effect a general RESET in the inbox queue and in the outbox buffer or to re-establish the default values of all parameters.

### Syntax

| Command | Possible Responses |
|---|---|
| AT+M2MPA=<ActionType> | OK |
| Observation: perform an action | Or |
| | +M2M ERROR: 4000 |
| | +M2M ERROR: 4001 |
| | +M2M ERROR: 4002 |
| AT+M2MPA? | OK |
| Observation: no effect | |
| AT+M2MPA=? | +M2MPA: (list of <Action> handled) |
| Observation: possible values | OK |
| AT+M2MPA=0 | OK |
| Observation: empties the inbox | Observation: reset carried out |
| queue and the outbox buffer and | |
| stops all current transactions | |
| AT+M2MPA=2 | +M2M ERROR: 4001 |
| Observation: perform an action | Observation: unauthorised operation |
| with an erroneous <ActionType> | |
| parameter | |
| AT+M2MPA? | OK |
| Observation: no effect | |
| AT+M2MPA=? | +M2MPA: (0-1) |
| Observation: possible values | OK |

### Specified Values

| | |
|---|---|
| <ActionType> | 0: RESET. Empties the inbox queue and the outbox |
| | buffer and stops all current transactions. |
| | 1: DEFAULT PARAMETERS. The default values of all |
| | the parameters of the AT commands are re-established. |
| | Action possible only off-connection. |

### Possible Error Codes

| | |
|---|---|
| +M2M ERROR: 4000 | The Wavecom Orange M2M protocol |
| | function is not activated. This error is |
| | returned when the Wavecom Orange M2M |
| | protocol function has not been activated in |
| | the WISMO module. |
| +M2M ERROR: 4001 | Operation denied. This error is returned |
| | when an erroneous parameter is detected. |
| +M2M ERROR: 4002 | Operation not supported by the current |
| | configuration. |

### 13.5 M2M Indications

This section describes all sent message event responses.

### 13.5.1 Connection Indications +M2MCONI

In order to allow the external application to know the connection status, a (+M2MCONI) connection indications mechanism is put in place.

These indications are sent when the <NotifyLevel> parameter value (see the +M2MGSET command) is set at 1 or 3.

Syntax: +M2MCONI: <Status>

| <Status> | |
|---|---|
| 0 | End of disconnection requested. |
| 1 | Connection established with the gateway |
| 2 | Connection refused by the gateway |
| 3 | Identification rejected by the gateway |
| 4 | Connection lost with the gateway |
| 5 | SMS wake-up received |

### 13.5.2 Send Message Indications +M2MSMI

To allow the external application to know if a message has been sent, a (+M2MSMI) message indications mechanism is put in place.

These indications are sent when the <NotifyLevel> parameter value (see the +M2MGSET command) is set at 2 or 3.

Syntax: +M2MSMI: <Status>,<MsgId>

| <Status> | |
|---|---|
| 0 | The <MsgId> message has been distributed |
| 1 | The <MsgId> message has been deleted (all restarts have |
| | failed) |
| 2 | The transmission of the <MsgId> message has failed. |
| <MsgId> | |
| (0-32767) | Message Identification |

### 13.5.3 Receive Message Indications +M2MRMI

If the size of the inbox is 0, the messages are displayed with the +M2MRMI indication as soon as they are received.

These indications are sent when the <NotifyLevel> parameter value (see the +M2MGSET command) is set at 2 or 3, during the receipt of messages with the AT+M2MRM command or if a message is received using the SMS support (with SMS, the gateway is able to send a message to the peripheral at any time).

| | |
|---|---|
| Syntax: | +M2MRMI: <Status>[,<MsgId>,[,<Bearer>,[<Length> |
| | <CR><LF> |
| | <Data>]] |
| <Status> | |
| 0 | The <MsgId> message is received in the inbox. |
| 1 | Message received without an inbox. The message is routed |
| | directly to the outbox. |
| 2 | Inbox saturated (the inbox no longer has enough room to store |
| | the message). The message is not acknowledged and remains |
| | stored at gateway level |
| 3 | No capacity to receive a message (the inbox is not big enough |
| | to store the message). If the <ForcedAcknowledge> |
| | parameter has been activated (ON), the unreceived message |
| | is acknowledged. |
| 4 | <MsgId> message corrupted: problem during WBXML |
| | decoding. |
| 5 | NMTS (nothing more to send) message received |
| <MsgId> | Identification of message received. (0-32767) |
| <Bearer> | 0: message sent by GPRS |
| | 1: message sent by SMS |
| <Length> | Length of useful data (in bytes). |
| <Data> | Message Data. |

### 13.5.4 Parse Message Indication +M2MPMI

Syntax: +M2MPMI: <Type>[,<Param1>,[,<Param2>]]

| | |
|---|---|
| <Type> | Type of operation |
| | 0: read a start indicator |
| | 1: read an attribute |
| | 2: read data |
| | 3: read an end indicator |
| | 4: end of message |
| | 5: XML message wrongly formed |
| | 6: memory allocation failure. |
| <Param 1> | with <Type 0>, start indicator name |
| | with <Type 1>, attribute name |
| | with <Type 2>, data value |
| | with <Type 3>, end indicator name |
| <Param 2> | only with <Type 1>, attribute value. |

### Error Codes

This section describes all the error codes returned by M2M AT commands.

| Error code | Significance |
|---|---|
| +M2M ERROR: 4000 | The Wavecom Orange M2M protocol function is |
| | not activated. This error is returned when the |
| | Wavecom Orange M2M protocol function has |
| | not been activated in the WISMO module. |
| +M2M ERROR: 4001 | Operation denied. This error is returned when an |
| | erroneous parameter is detected. |
| +M2M ERROR: 4002 | Operation not supported by the current |
| | configuration. |
| +M2M ERROR: 4003 | Service already connected |
| +M2M ERROR: 4004 | Connection operation pending |
| +M2M ERROR: 4005 | Disconnection operation pending |
| +M2M ERROR: 4006 | Service not connected |
| +M2M ERROR: 4007 | No network |
| +M2M ERROR: 4008 | No GPRS |
| +M2M ERROR: 4009 | No TCP/IP |
| +M2M ERROR: 4010 | Queue saturated |
| +M2M ERROR: 4011 | Message cannot be found |
| +M2M ERROR: 4012 | Uncoded XML text message to be sent on SMS is |
| | too long; it exceeds 160 bytes. |
| +M2M ERROR: 4013 | No unsolicited message function on GPRS. |
| +M2M ERROR: 4014 | The solicited message is not compressed by |
| | WBXML. |
| +M2M ERROR: 4015 | No message in the queue. |
| +M2M ERROR: 4016 | Indicator cannot be found in the input buffer. |
| +M2M ERROR: 4017 | Error during analysis of the input buffer |
| | (violation of XML rules or memory allocation |
| | failure). |
| +M2M ERROR: 4018 | Attribute cannot be found in the input buffer. |
| +M2M ERROR: 4019 | Impossible to modify the XML document since it |
| | is currently being created. |
| +M2M ERROR: 4020 | XML document fully created (in other words the |
| | root element is closed). Try (ActionType 7 or 8) |
| | modification operations. |

One or more embodiments of the invention overcome drawbacks of the prior art.

It should be noted that the fact of identifying this problem is per se a part of an embodiment of the invention. Indeed, the person skilled in the art is convinced that it is absolutely necessary to equip terminal equipment with sufficient processing means, and is unable under any circumstances to conceive how it is possible to reduce them, or even eliminate them.

An embodiment of the invention makes it possible to simplify the required processing operations on the equipment side, and to prevent such equipment from having to have complex and expensive means such as a microprocessor.

An embodiment of the invention proposes a straightforward and generic technique that allows a dialogue to be established easily and effectively between a remote terminal of “limited intelligence” and a server using a high-level protocol, understood by this server.

An embodiment of the invention provides such a technique, allowing a connection to be established between servers and equipment by wireless telephony, in a simple, standardised and inexpensive manner.

An embodiment of the invention provides such a technique, allowing a substantial number of applications to be developed, without it being necessary to develop specific applications on each occasion.

An embodiment of the invention provides such a technique, which does not require knowledge of the protocol and/or data format used in the applications developed.

An embodiment of the invention provides such a technique, which is at once technically simple and expandable, and adaptable to different situations (for example for the size of data to be exchanged) and to any future developments.

Although the present disclosure has been described with reference to preferred embodiments, workers skilled in the art will recognize that changes may be made in form and detail without departing from the spirit and scope of the invention.

1. System for remotely monitoring equipment, allowing interconnection between at least one server and at least one remote equipment according to a given protocol, the system comprising:
a radiocommunication device associated with at least one of said remote equipment, wherein the device is able to send and receive AT type commands sent by and/or intended to an external application implemented by said remote equipment,
wherein said radiocommunication device is endowed with a set of specific AT commands allowing data exchanges to be managed between said remote equipment and at least one server implementing said given protocol, and
wherein at least one of said AT commands allow said radiocommunication device to create, modify and/or send pages in the XML format, so as to allow interconnection between said at least one server and said at least one remote equipment via said radiocommunication device by transmitting pages in the XML format, without requiring knowledge of said given protocol nor the XML format in said at least one remote equipment.

2. System for remotely monitoring equipment according to claim 1, wherein at least one of said AT commands allows transmission data to be compressed.

3. System for remotely monitoring equipment according to claim 2, wherein said compression implements the WBXML compression format.

4. System for remotely monitoring equipment according to claim 1, wherein, at least in a first transmission mode, said radiocommunications device is configured to transmit said data is on a channel dedicated to short messages (SMS).

5. System for remotely monitoring equipment according to claim 1, wherein, at least in a second transmission mode, said radiocommunications device is configured to transmit said data on a GPRS channel.

6. System for remotely monitoring equipment according to claim 5, wherein, in said second operating mode, said system implements a “peer-to-peer” protocol, using the TCP protocol.

7. System for remotely monitoring equipment according to claim 6, wherein said “peer-to-peer” protocol is the BEEP protocol.

8. System for remotely monitoring equipment according to claim 1 and further comprising means for the implementation, in a first operating mode, of a service for the automatic sending and/or receiving of at least one XML message stored in said radiocommunication device, on receipt of a wake-up message.

9. System for remotely monitoring equipment according to claim 8, wherein the system has four operating modes:
automatic mode, in which it manages a transaction autonomously;
manual mode, in which a transaction must be initiated by a remote application;
automatic input/manual output mode, in which only incoming messages are processed automatically; and
manual input/automatic output mode, in which a message is sent automatically.

10. System for remotely monitoring equipment according to claim 1, wherein the system implements simplified XML pages, comprising only:
tag names;
attribute values; and/or
data.

11. System for remotely monitoring equipment according to claim 1, wherein the system implements said given protocol in the frame of a service using an XML data description language, an algorithm for the compression of said WBXML data, a first method of access to at least one server via GPRS and a second method of access to a second server via SMS.

12. System for remotely monitoring equipment according to claim 11, wherein said service is the “M2M Connect” service developed by the Orange Company (trademark).

13. System for remotely monitoring equipment according to claim 1 wherein said radiocommunication device integrates said protocol in the form of an “Open-AT” application, specifying said specific set of AT commands.

14. System for remotely monitoring equipment according to claim 1, wherein said set of specific AT commands includes commands allowing:
connection to one of said servers;
the sending of messages; and
the receipt of messages.

15. System for remotely monitoring equipment according to claim 1, wherein at least some of said specific AT commands are organised so as to be able to provide at least two functions and/or act on at least two distinct aspects, as a function of a preset parameterisation.

16. System for remotely monitoring equipment according to claim 1, wherein said set of commands comprises only 8 commands.

17. System for remotely monitoring equipment according to claim 1, wherein said set of specific AT commands includes a least one configuration command allowing the parameters of communication to be defined with one of said servers.

18. System for remotely monitoring equipment according to claim 17, wherein the system implements a single configuration command (+M2MGSET) for the general configuration of aspects related to said protocol and/or said service.

19. System for remotely monitoring equipment to claim 17 wherein said configuration command allows a transmission mode to be selected from at least two modes comprising SMS and GPRS.

20. System for remotely monitoring equipment according to claim 17, wherein said configuration command allows a operating mode selected from at least two, an automatic operating mode and a manual operating mode.

21. System for remotely monitoring equipment according to claim 20, wherein said configuration command allows a deadline to be set for handling a message, in said automatic operating mode.

22. System for remotely monitoring equipment according to claim 1, wherein the system implements at least three configuration commands:
a command for the general configuration of aspects related to said protocol and/or said service (+M2MGSET);
a connection configuration command (+M2MCSET), allowing in particular to specify the coordinates of a server; and
a command for the configuration of a table configuration message for implementing a syntactic analyser for compression (+M2MWBXML) .

23. System for remotely monitoring equipment according to claim 1, at least in a first mode, said radiocommunication device only manages the signalling of a data exchange, said data being transferred directly from at least one of the remote equipment to at least one of the servers, or vice versa.

24. System for remotely monitoring equipment according to claim 23, wherein, at least in a second mode, said radiocommunication device manages the signalling of a data exchange and the transfer of said data, the latter being stored temporarily in at least one buffer memory.

25. System for remotely monitoring equipment according to claim 24, wherein the the at least one buffer memory comprises a parameterised size.

26. System for remotely monitoring equipment according to claim 24, wherein the system operates in said first mode when the size of said at least one buffer memory has the value 0, and in said second mode otherwise.

27. System for remotely monitoring equipment according to claim 1, wherein the system implements at least one general communication command, allowing messages to be sent and/or received according to said given protocol.

28. System for remotely monitoring equipment according to claim 27, wherein the system implements at least five general communication commands:
a command for the management of a connection with a server (+M2MCONM);
a sending message command (+M2MSMSG);
an XML message creation and/or modification command (+M2MCMSG);
a receipt message receive command (+M2MRMSG);
an administration command, allowing a set of parameters (+M2MPA) to be reset and/or returned to the default values.

29. System for remotely monitoring equipment according to claim 27, wherein the system includes:
an XML message creation and/or modification command (+M2MCMSG) allowing at least some of the following operations to be performed:
starting the creation of an XML message in an output buffer;
writing a start indicator;
writing an attribute;
writing data;
writing an end indicator;
end of page creation;
modifying an attribute value;
modifying a data value,
a parameter making it possible to determine the type of operation to which said creation and/or modification command is assigned.

30. System for remotely monitoring equipment according to claim 1, wherein the system implements at least one interrogation command by an external application.

31. System for remotely monitoring equipment according to claim 30, wherein the system implements four interrogation commands by an external application in one of said remote equipment, in relation respectively to:
the current status of the connection (+M2MCONI);
the sending of a message (+M2MSMSGI);
the receipt of a message (+M2MRMSGI);
the syntactic analysis or “parsing” of a message (+M2MPMSGI).

32. Process for remotely controlling equipment, allowing interconnection between at least one server and at least one remote equipment according to a given protocol, the process comprising:
associating with at least one of said remote equipment a radiocommunication device able to send and receive AT type commands sent by and/or intended to an external application implemented by said equipment,
implementing in said radiocommunication device, a set of specific AT commands allowing data exchanges to be managed between said remote equipment and at least one server implementing said given protocol,
at least one of said AT commands allowing said radiocommunication device to create, modify and/or send pages in the XML format, so as to allow interconnection between said at least one server and said at least one remote equipment via said radiocommunication device by transmitting pages in the XML format, without requiring knowledge of said given protocol nor the XML format in said at least one remote equipment.

33. Radiocommunication device wherein it includes radio communication means implemented in a system for remotely monitoring equipment according to claim 1.

34. Radiocommunication module wherein it includes radiocommunication device implemented in a system for remotely monitoring equipment according to claim 1.

35. Computer program wherein it includes programming instructions allowing the implementation of AT type commands in a remote equipment and/or in a radiocommunication device of a system for remotely monitoring the equipment.
the programming instructions including instructions enabling the device to send and receive AT type commands sent by and/or intended to an external application implemented by said remote equipment, wherein said AT commands allow data exchanges to be managed between said remote equipment and at least one server implementing a given protocol, and wherein at least one of said AT commands allow said radiocommunication device to create, modify and/or send pages in the XML format, so as to allow interconnection between said at least one server and said at least one remote equipment via said radiocommunication device by transmitting pages in the XML format, without requiring knowledge of said given protocol nor the XML format in said at least one remote equipment.
